(19) United States
(12) Patent Application Publication
(10) Pub. No.: US 2008/0151851 A1
(43) Pub. Date: Jun. 26, 2008

(54) METHOD AND APPARATUS FOR PROVIDING NETWORK SELECTION

(75) Inventor: Paul K. Sitch, Hangzhou (CN)

Correspondence Address: DITTHAVONG MORI & STEINER, P.C., 918 Prince St., Alexandria, VA, 22314, US

(73) Assignee: NOKIA CORPORATION, ESPOO (FI)

(21) Appl. No.: 11/952,518

(22) Filed: Dec. 7, 2007

Related U.S. Application Data
(60) Provisional application No. 60/869,126, filed on Dec. 8, 2006.

(51) Int. Cl. H04Q 7/24

(52) U.S. Cl. 370/338

(57) ABSTRACT

An approach is provided for a network selection process. A user equipment selects a service provider based on a selection criteria. An advertisement procedure is initiated to select one of a plurality of networks associated with the service provider to access.

### RELATED APPLICATIONS

This application claims the benefit of the earlier filing date under 35 U.S.C. §119(e) of U.S. Provisional Application Ser. No. 60/869,126 filed Dec. 8, 2006, entitled “Method and Apparatus For Providing Network Selection,” the entirety of which is incorporated herein by reference.

### BACKGROUND

Radio communication systems, such as WiMAX (Worldwide Interoperability for Microwave Access) compatible networks, and Third Generation Partnership Project (3GPP) systems), provide users with the convenience of mobility along with a rich set of services and features. This convenience has spawned significant adoption by an ever growing number of consumers as an accepted mode of communication for business and personal uses. Moreover, multiple radio networks co-exist to provide different and/or complementary services and coverage. In order to take advantage of the variety and diversity of such services, network selection procedure is required. To promote greater adoption, the telecommunication industry, from manufacturers to service providers, has agreed at great expense and effort to develop standards for communication protocols that underlie the various services and features. One key area of effort involves network selection in the context of internetworking. For example, conventional approaches do not provide procedures for selecting a network in an interworking environment.

### SOME EXEMPLARY EMBODIMENTS

Therefore, there is a need for an approach to provide an effective network selection procedure for interworking wireless systems.

According to one embodiment of the invention, a method comprises selecting, via a user equipment, a service provider based on a selection criteria. The method also comprises initiating an advertisement procedure to select one of a plurality of networks associated with the service provider to access.

According to another embodiment of the invention, an apparatus comprises selection logic configured to select, at a user equipment, a service provider based on a selection criteria. An advertisement procedure is initiated to select one of a plurality of networks associated with the service provider to access.

According to another embodiment of the invention, a mobile device comprising selection logic configured to select a service provider based on a selection criteria. An advertisement procedure is initiated to select one of a plurality of networks associated with the service provider to access.

According to another embodiment of the invention, a method comprises transmitting a list specifying a plurality of service providers to a user equipment, wherein the user equipment is configured to select one of the service providers based on a selection criteria and to initiate an advertisement procedure to select one of a plurality of networks associated with the one service provider to access. The method also comprises receiving a message, from the user equipment, specifying information about the selected network.

According to yet another embodiment of the invention, a base station apparatus comprises a transceiver configured to transmit a list specifying a plurality of service providers to a user equipment, wherein the user equipment is configured to select one of the service providers based on a selection criteria and to initiate an advertisement procedure to select one of a plurality of networks associated with the one service provider to access. The transceiver is further configured to receive a message, from the user equipment, specifying information about the selected network.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a wireless terminal capable of performing network selection, in accordance with an embodiment of the invention;

FIGS. 2A and 2B are flowcharts of network selection processes, according to various embodiments;

FIG. 3 is a diagram of a network discovery and selection procedure in a Worldwide Interoperability for Microwave Access (WiMAX) environment;

FIG. 4 is a diagram of an exemplary network advertisement procedure in an interworking wireless local area network (WLAN) (I-WLAN);

FIG. 5 is a diagram of an exemplary network advertisement procedure in a WiMAX environment, according to an embodiment of the invention;

FIG. 6 is a diagram of a network discovery and selection procedure utilizing a network service provider list stored within a user equipment, according to an embodiment of the invention;

FIG. 7 is a diagram of hardware that can be used to implement an embodiment of the invention; and

FIG. 8 is a diagram of exemplary components of a mobile station capable of operating in the system of FIG. 1, according to an embodiment of the invention.

### DESCRIPTION OF PREFERRED EMBODIMENTS

An apparatus, method, and software for network selection in a communication network are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to wireless networks compliant with the IEEE 802.16 architecture (i.e., also referred to as “‘WirelessMAN’ ” as specified by the WiMax (Worldwide Interoperability for Microwave Access) Forum) and Third Generation Partnership Project (3GPP) architectures, it is recognized by one of ordinary skill in the art that the embodiments of the inventions have applicability to other types of radio communication system and other radio technologies.

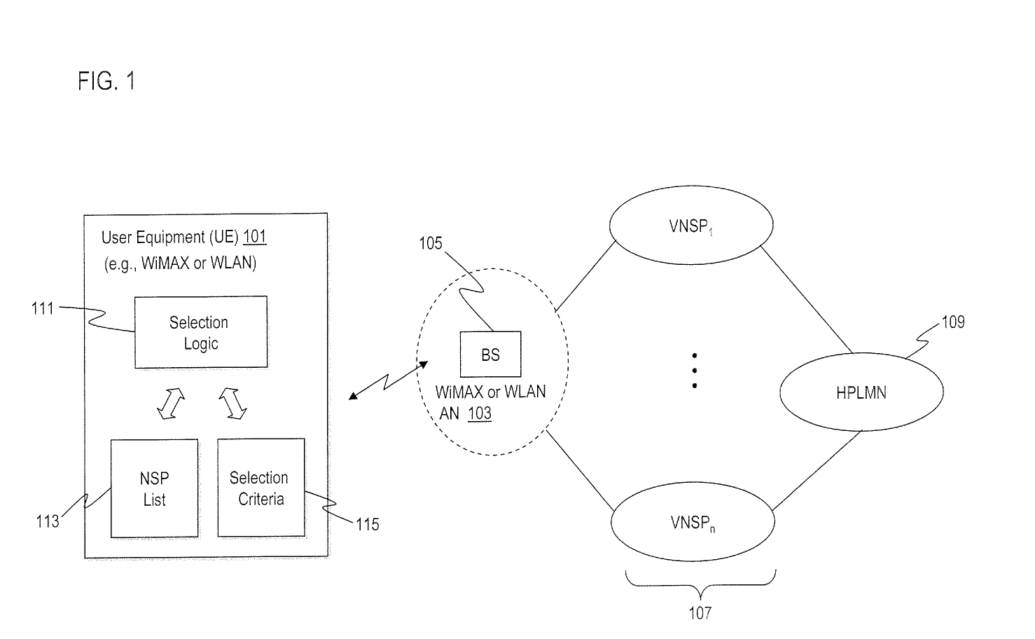

FIG. 1 is a diagram of a wireless terminal capable of performing network selection, in accordance with an embodiment of the invention. As used herein, a user equipment (UE) 101 can be referred to as a terminal or a station. The UE 101 can be any communication device, including phones, mobile station, wireless terminal, Personal Digital Assistants (PDAs), and computers of various types (laptops, personal computers, workstations, terminals of any type). According to an exemplary embodiment, the user equipment 101, may be in a coverage area of a WiMAX or a wireless local area network (WLAN) Access Network (AN) 103. Although only a single AN 103 is depicted, it is recognized that multiple ANs can exist. The access network 103, which includes a base station (BS) 105 configured to communicate with the UE 101, provides the WiMAX (or WLAN) access services. The AN 103, for example, can have a multitude of roaming agreements with visited network service providers (e.g., VNSP₁ . . . VNSP_{N}) 107. These VNSPs 107 communicate with a home public land mobile network (HPLMN) 109 to which the user is subscribed.

As seen, the UE 101 employs a selection logic 111 for performing network selection. In an exemplary embodiment, the UE 101 maintains a network service provider (NSP) list 113 of preferred network service providers. In the alternative (or in conjunction with), a selection criteria 115 is used by the selection logic 111.

A network advertisement procedure is utilized to discover available network service providers (NSPs) 107. The UE 101 samples each available NSPs 107 with unroutable network access identifier (NAI) to find public land mobile networks (PLMNs) 109 that can support the selection process. In an exemplary embodiment, available NSPs 107 can be listed based on a service agreement, and the UE 101 can select NSPs 107 from a N SP list 113 by utilizing the selection logic 111 based on the selection criteria 115. After the selection process, the list 113 can be presented to the user to select an NSP. In one embodiment, the “first” or “highest” (i.e., most preferred) network service providers on the list can be provided. The list 113 can be stored in any storage medium, e.g., local memory, smartcard, etc.

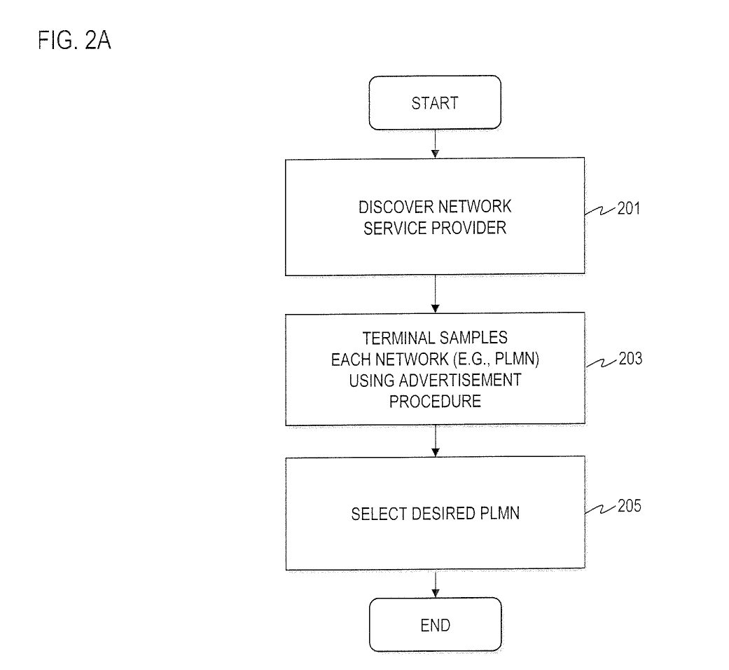

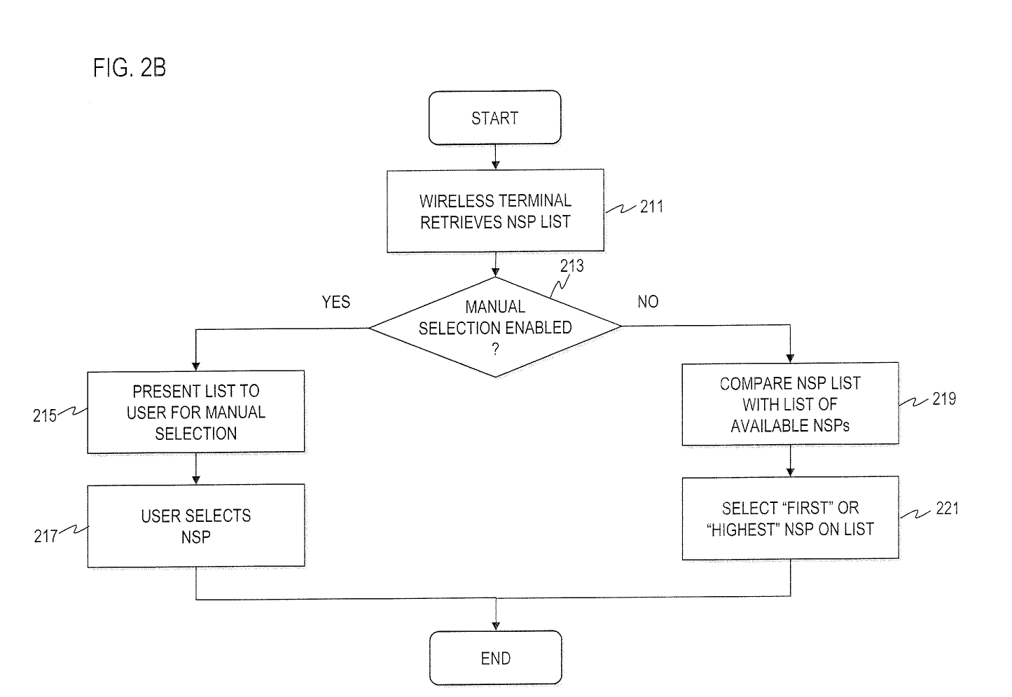

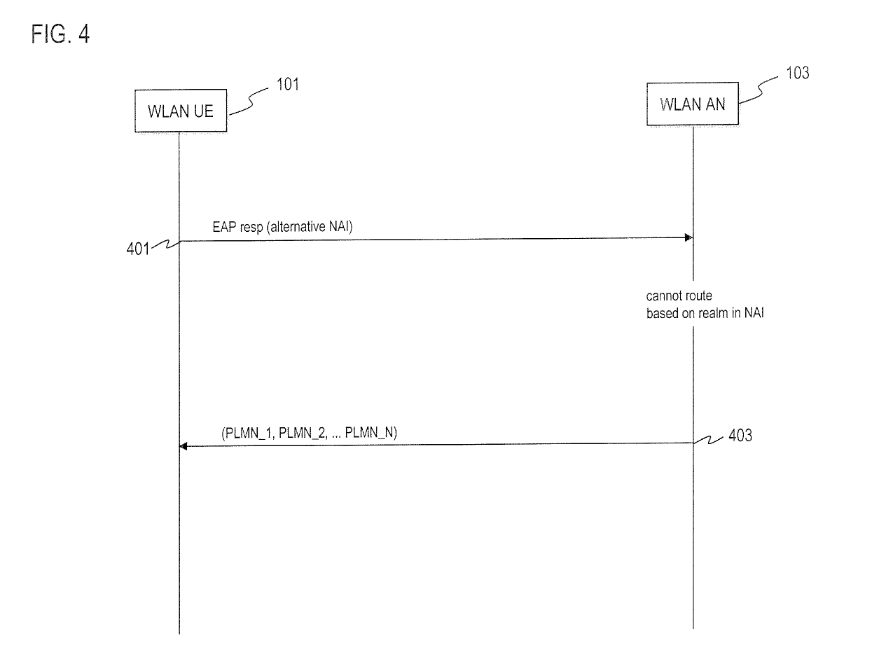

FIGS. 2A and 2B are flowcharts of network selection processes, according to various embodiments. These processes are explained with respect to the system of FIG. 1. Under this scenario, in step 201, the UE 101 (within the coverage of WiMAX or WLAN AN 103) discovers a network service provider while performing network selection process to gain access to a wireless network. In step 203, the UE 101 samples each network (e.g., PLMN 109) using an advertisement procedure, as more fully described below in FIG. 4. Additionally, the advertisement procedure can be executed in accordance with Internet Engineering Task Force (IETF) Request for Comment (RFC) 4284 (which is incorporated herein by reference in its entirety). Using the advertisement procedure, the UE 101 selects a desired PLMN 109, per step 205.

As shown in FIG. 2B, the UE 101 retrieves the NSP list 113 based on, for example, a selection roaming agreement between a WiMAX provider and a cellular service provider, per step 211. Thereafter, the UE 101 then determines whether manual selection is provided, as in step 213. If manual selection is enabled, as in step 215, the UE 101 presents the NSP list 113 to the user for selection. In step 217, the user selects the desired NSP. If manual selection option is not enabled, the UE 101 compares the list of available NSPs with the stored list of NSPs (step 219). Based on the comparison, the UE 101 selects the “first” or “highest” NSP among available NSP list 113 (step 221).

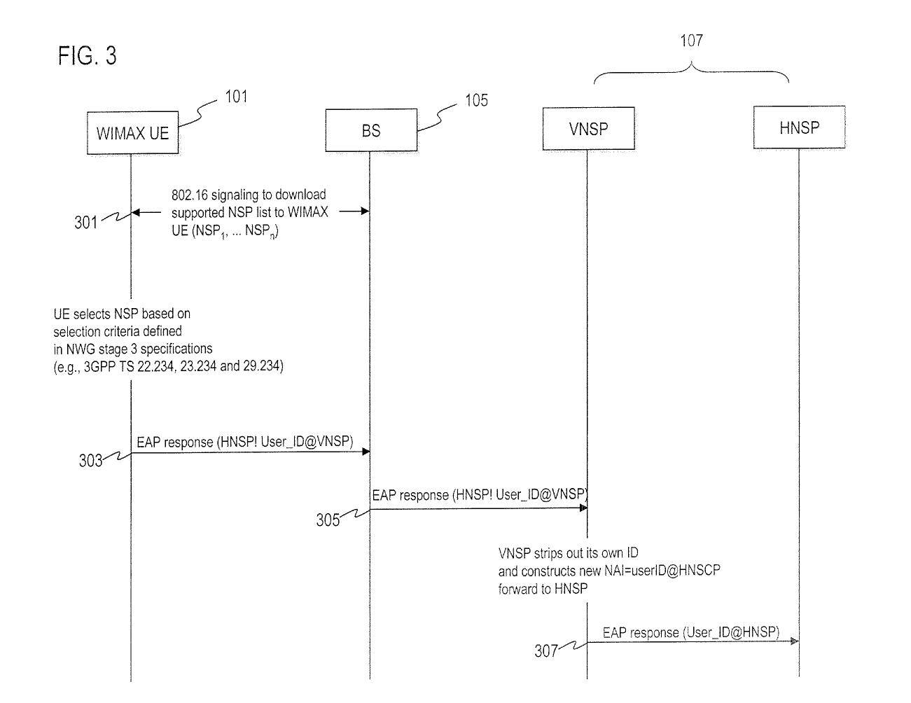

FIG. 3 is a diagram of a network discovery and selection procedure in a Worldwide Interoperability for Microwave Access (WiMAX) environment. To gain access to the WiMAX network, the UE 101 performs network selection to enable WiMAX service. The selection process can involve the UE 101 accessing a Network Access Point (NAP) (not shown), and discovering a particular Network Service Provider (NSP) among multiple NSPs 107 behind the NAP.

In step 301, the UE 101 accesses WiMAX AN 103 to establish a connection using a selection process via BS 105. During a selection process, the UE 101 can select the desired NSP 107 based on predefined selection criteria 107. According to one embodiment, the UE 101 can select NSPs 107 using the NSP preference list 113. By way of example, Extensible Authentication Protocol (EAP) messages, as shown, are utilized to communicate among the network entities; it is recognized, however, that other equivalent protocols can be used. The EAP protocol provides an authentication framework, specifying information about network connectivity and roaming relationships in a wireless environment. In this example, in step 303, UE 101 sends an EAP response message (e.g., HNSPI! User_ID@VNSP) to BS 105; and the EAP response message is transferred to VNSP (Visited NSP) 107, per step 305. The VNSP 107, then, strips out its own ID and constructs a new network Access Identifier (NAT). After modifying the message, the VNSP 107 then forwards the new NAT to the HNSP (Home NSP) 107 (e.g., EAP response (User_ID@HNSP)), per step 307.

FIG. 4 is a diagram of an exemplary network advertisement procedure in an interworking wireless local area network (WLAN) (I-WLAN). In a 3GPP scenario, a PLMN selection procedure involves the UE 101 scanning for and finding an available WLAN AN APs (Access Points) (e.g., SSIDs (Service Set Identifiers)). The UE 101 then discovers which PLMNs 109 are accessible behind the respective SSIDs. Using, for example, the list 113 of preferred networks stored in a smart card, the UE 101 can determine the required PLMN 109 and the associated SSID. To discover the available PLMNs 109, a network advertisement procedure can be utilized.

In step 401, the UE 101 can send a Network Access Identifier (NAT) to the WLAN AN 103. It is noted, however, that the NAT cannot be routed. The WLAN AN 103 responds, in step 403, with a list of all available PLMNs 109. PLMN selection procedures are specified in 3GPP TS 22.234, 23.234 and 29.234, which are incorporated herein by reference in their entireties.

In case of the WiMAX-3GPP interworking, where the UE 101 uses subscription information with 3GPP operator to obtain connectivity to the WiMAX network (e.g., AN 103), it is difficult to determine what PLMNs 109 are available behind specific NAPs (not shown). Namely, once a NSP 107 is selected, the UE 101 has no means of discovering the associated PLMNs 109 i.e., routable through the NSP 107.

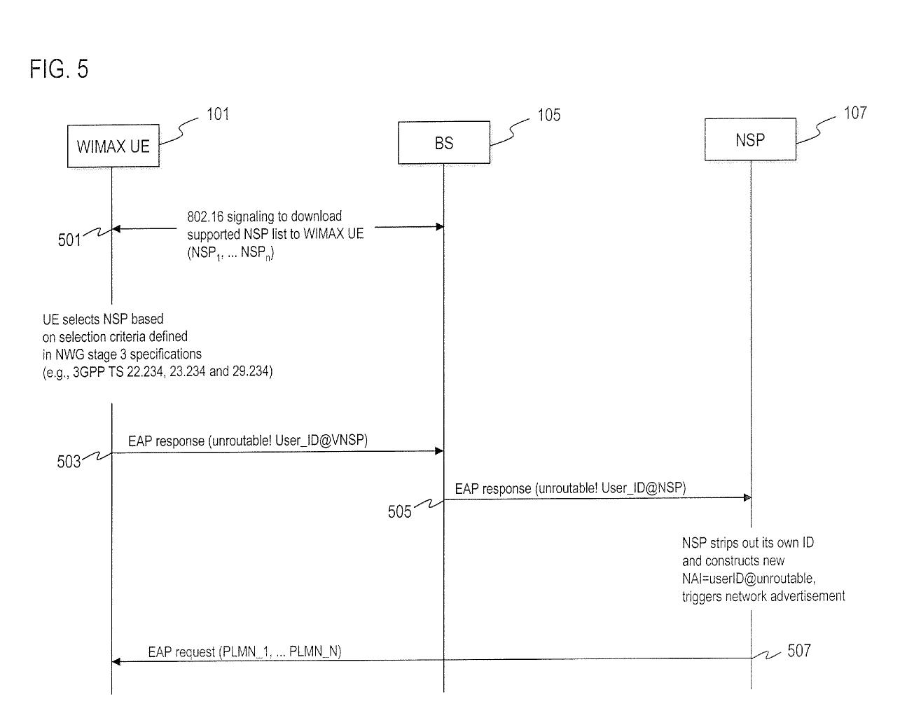

FIG. 5 is a diagram of a network advertisement procedure in a WiMAX environment, according to an embodiment of the invention. To enable network selection after NSP discovery, an AAA (Authentication, Authorization, and Accounting) proxy/server (not shown) within the NSP network, can implement a PLMN advertisement procedure, According to one embodiment, the procedure defined in RFC 4284 can be utilized. In this scenario, PLMN selection can proceed according to the procedures defined in the 3GPP. As such, a wireless terminal can sample each available NSP with an unroutable NAT to determine the PLMNs that are supported.

In step 501, UE 101 accesses WiMAX AN 103 via BS 105 to establish a connection using a selection process. During the selection process, the UE 101 can select the desired NSP based on predefined selection criteria 115 defined in the selection procedures. In an exemplary embodiment, Extensible Authentication Protocol (EAP) response message, as shown, are utilized to communicate among the network entities. In this example, the UE 101 sends, as in step 503, EAP response message (e.g., unroutable User_ID@VNSP) to BS 105 and the BS 105 transfers the EAP response message (e.g., unroutable User_ID@NSP) to NSP 107, per step 505. The VNSP 107 subsequently strips or parses out its own ID and utilizes a new network Access Identifier (NAI) (e.g., NAI=userID@unroutable) for triggering network advertisement. In step 507, the NSP 107 transmits an EAP request (PLMN_{—}1, . . . PLNM_N) to the UE 101.

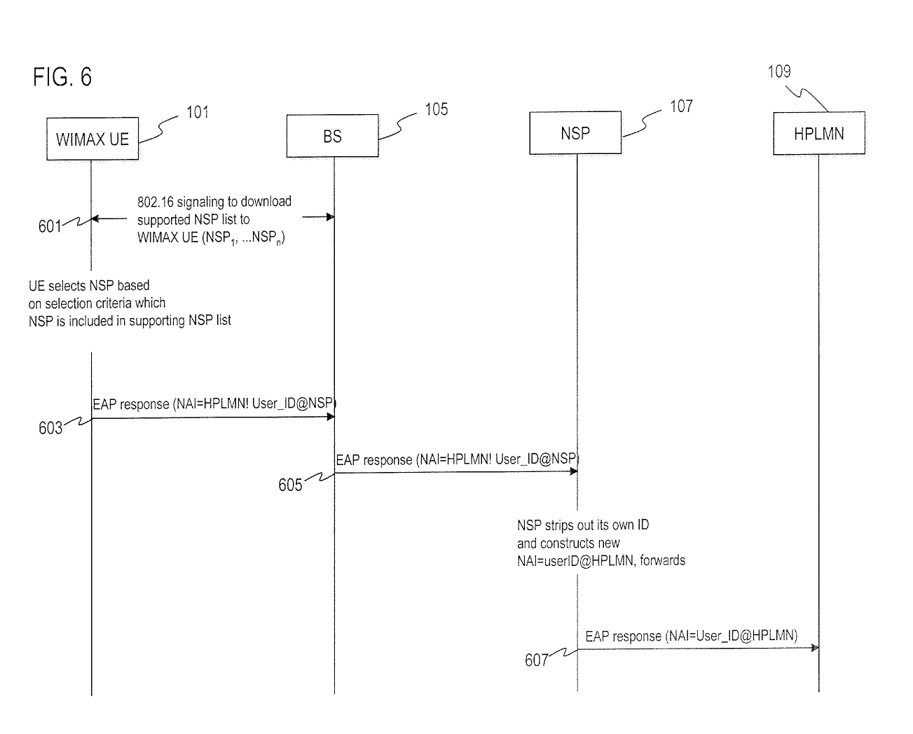

FIG. 6 is a diagram of a network discovery and selection procedure utilizing a network service provider list stored within a user equipment, according to an embodiment of the invention. As previously explained, in an exemplary embodiment, the UE 101, as an WiMAX enabled 3GPP compatible interworking device, contains the list 113 of WiMAX NSPs 107. These NSPs 107 can represent, for example, the WiMAX providers with which the 3GPP operator has a roaming agreement.

After WiMAX network discovery, the UE 101 can either: (i) present the NSPs 407 to the user for selection (i.e., manual selection case); or (ii) compare the list of available NSPs 107 with the stored list of NSPs 105, and selects the first NSP on the list. This procedure avoids the need for PLMN selection in the NSP 107. Thus, the UE 101 can then decorate the NAT accordingly to gain connectivity to the HPLMN (Home Public Land Mobile Network) 109.

In step 601, the UE 101 accesses WiMAX AN 103 via BS 105 to download the supported NSP list 113 (e.g., NSP₁, . . . , NSPₙ) as part of the selection process. The UE 101 selects an NSP 107 from the NSP list 113. Next in step 603, the UE 101 generates a message, e.g., Extensible Authentication Protocol (EAP) response message, to convey the selected NSP to the BS 105. The EAP response message, for instance, specifies “NAI=HPLMN! User_ID@NSP.” The BS 105 relays the EAP response message to NSP 107, per step 605. The NSP 107 then replaces its own ID with a new network Access Identifier (NAI) (e.g., NAI=userID@HPLMN). The NSP 107 subsequently sends a response message (NAI=userID@HPLMN) to HPLMN 109, per step 607.

The above arrangement simplifies network selection in a wireless (e.g., WiMAX) interworking environment.

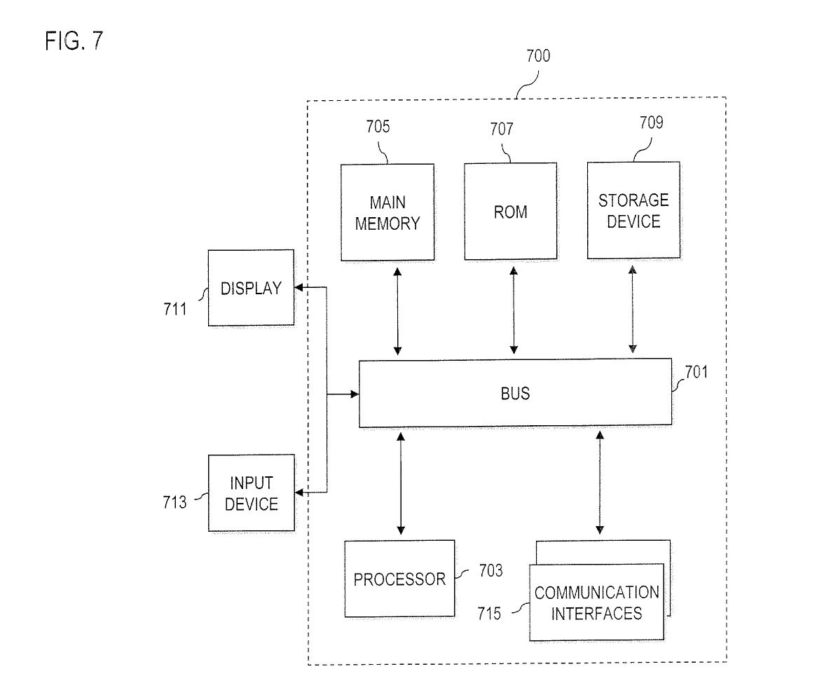

One of ordinary skill in the art would recognize that the processes for providing network selection may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 7.

FIG. 7 illustrates exemplary hardware upon which various embodiments of the invention can be implemented. A computing system 700 includes a bus 701 or other communication mechanism for communicating information and a processor 703 coupled to the bus 701 for processing information. The computing system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computing system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing in formation and instructions.

The computing system 700 may be coupled via the bus 701 to a display 711, such as a liquid crystal display, or active matrix display, for displaying information to a user. An input device 713, such as a keyboard including alphanumeric and other keys, may be coupled to the bus 701 for communicating information and command selections to the processor 703. The input device 713 can include a cursor control such as a mouse, a trackball, or cursor direction keys, for communicating direction information and command selections to the processor 703 and for controlling cursor movement on the display 711.

According to various embodiments of the invention, the processes described herein can be provided by the computing system 700 in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 700 also includes at least one communication interface 715 coupled to bus 701. The communication interface 715 provides a two-way data communication coupling to a network link (not shown). The communication interface 715 sends and receives electrical, electromagnetic, or optical signals that carry digital data streams representing various types of information. Further, the communication interface 715 can include peripheral interface devices, such as a Universal Serial Bus (USB) interface, a PCMCIA (Personal Computer Memory Card International Association) interface etc.

The processor 703 may execute the transmitted code while being received and/or store the code in the storage device 709, or other non-volatile storage for later execution. In this manner, the computing system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

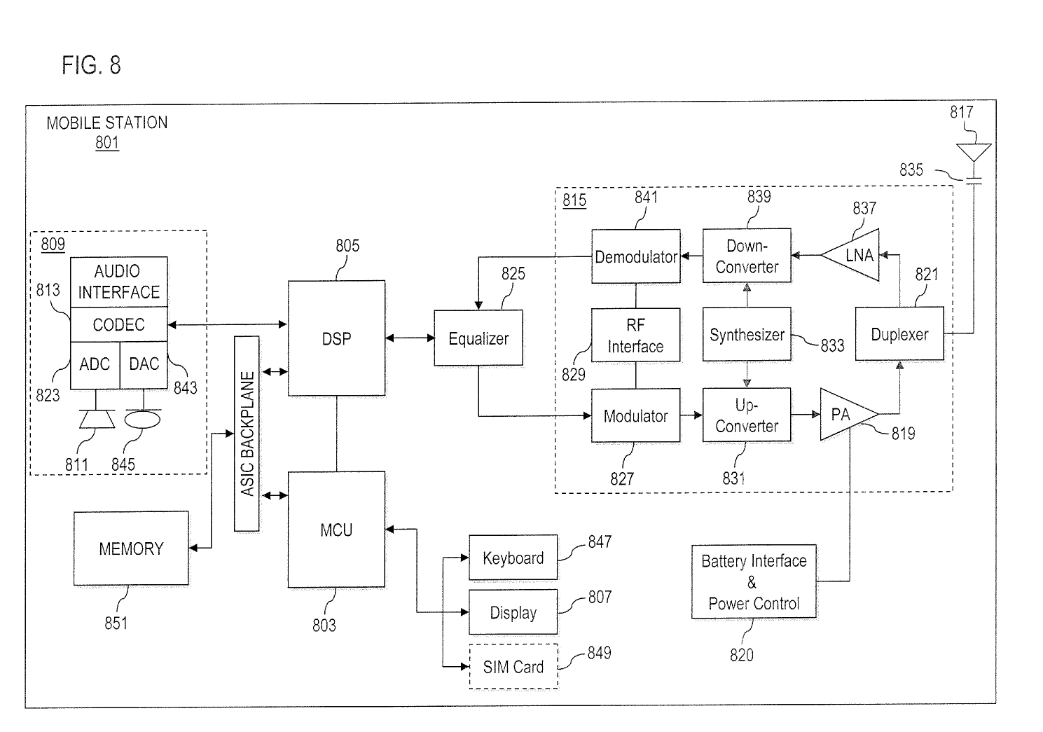

FIG. 8 is a diagram of exemplary components of a mobile station capable of operating in the system of FIG. 1, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., system of FIG. 1), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using a wireless transmission protocol.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver.

Signals (e.g., voice or audio signals) transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 maybe, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number) the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
selecting, via a user equipment, a service provider based on a selection criteria; and
initiating an advertisement procedure to select one of a plurality of networks associated with the service provider to access.

2. A method according to claim 1, further comprising:
sampling a plurality of service providers including the service provider with unroutable network access identifiers (NAIs) to determine availability of the service providers for selection.

3. A method according to claim 1, further comprising:
generating a message for transmission to a base station of the service provider, wherein the message specifies a network access identifier (NAI) associated with the one selected network.

4. A method according to claim 3, wherein the network access identifier within the message is modified by the network service provider, the modified message being forwarded to the selected network.

5. A method according to claim 4, wherein the message is generated according to an extensible authentication protocol (EAP).

6. A method according to claim 1, wherein the user equipment supports Institute of Electrical and Electronic Engineers (IEEE) 802.16 WiMax protocols, and the selected network is a Third Generation Partnership Project (3GPP) system.

7. A method according to claim 1, wherein the user equipment selects the network service provider from a list specifying a plurality of service providers.

8. A method according to claim 7, further comprising:
receiving the list from the base station,
wherein the user equipment is configured to present the list to the user for manual selection, or to compare the list with a list of available network service providers.

9. An apparatus comprising:
selection logic configured to select, at a user equipment, a service provider based on a selection criteria,
wherein an advertisement procedure is initiated to select one of a plurality of networks associated with the service provider to access.

10. An apparatus according to claim 9, wherein the selection logic is further configured to sample a plurality of service providers including the service provider with unroutable network access identifiers (NAIs) to determine availability of the service providers for selection.

11. An apparatus according to claim 9, further comprising:
a processor configured to generate a message for transmission to a base station of the service provider, wherein the message specifies a network access identifier (NAI) associated with the one selected network.

12. An apparatus according to claim 11, wherein the network access identifier within the message is modified by the network service provider, the modified message being forwarded to the selected network.

13. An apparatus according to claim 12, wherein the message is generated according to an extensible authentication protocol (EAP).

14. An apparatus according to claim 9, wherein the user equipment supports Institute of Electrical and Electronic Engineers (IEEE) 802.16 WiMax protocols, and the selected network is a Third Generation Partnership Project (3GPP) system.

15. An apparatus according to claim 9, wherein the user equipment selects the network service provider from a list specifying a plurality of service providers.

16. An apparatus according to claim 15, wherein the user equipment is configured to present the list to the user for manual selection, or to compare the list with a list of available network service providers.

17. A mobile device comprising:
selection logic configured to select a service provider based on a selection criteria,
wherein an advertisement procedure is initiated to select one of a plurality of networks associated with the service provider to access.

18. A device according to claim 17, wherein the selection logic is further configured to sample a plurality of service providers including the service provider with unroutable network access identifiers (NAIs) to determine availability of the service providers for selection.

19. A device according to claim 17, further comprising:
a processor configured to generate a message that specifies a network access identifier (NAI) associated with the one selected network; and
a transceiver configured to transmit the message to a base station of the service provider.

20. A device according to claim 19, wherein the network access identifier within the message is modified by the network service provider, the modified message being forwarded to the selected network.

21. A device according to claim 20, wherein the message is generated according to an extensible authentication protocol (EAP).

22. A device according to claim 17, wherein the user equipment supports Institute of Electrical and Electronic Engineers (IEEE) 802.16 WiMax protocols, and the selected network is a Third Generation Partnership Project (3GPP) system.

23. A device according to claim 17, wherein the user equipment selects the network service provider from a list specifying a plurality of service providers.

24. A device according to claim 23, wherein the user equipment is configured to present the list to the user for manual selection, or to compare the list with a list of available network service providers.

25. A method comprising:
transmitting a list specifying a plurality of service providers to a user equipment, wherein the user equipment is configured to select one of the service providers based on a selection criteria and to initiate an advertisement procedure to select one of a plurality of networks associated with the one service provider to access; and
receiving a message, from the user equipment, specifying information about the selected network.

26. A method according to claim 25, wherein the message specifies a network access identifier (NAI) associated with the selected network.

27. A method according to claim 26, further comprising:
forwarding the message to the network service provider, wherein the network access identifier within the message is modified by the network service provider, and the modified message is forwarded to the selected network.

28. A method according to claim 27, wherein the message is compliant with an extensible authentication protocol (EAP).

29. A method according to claim 25, wherein the user equipment supports Institute of Electrical and Electronic Engineers (IEEE) 802.16 WiMax protocols, and the selected network is a Third Generation Partnership Project (3GPP) system.

30. A method according to claim 25, wherein the user equipment is configured to present the list to the user for manual selection, or to compare the list with a list of available network service providers.

31. A base station apparatus comprising:
a transceiver configured to transmit a list specifying a plurality of service providers to a user equipment, wherein the user equipment is configured to select one of the service providers based on a selection criteria and to initiate an advertisement procedure to select one of a plurality of networks associated with the one service provider to access,
wherein the transceiver is further configured to receive a message, from the user equipment, specifying information about the selected network.

32. An apparatus according to claim 31, wherein the message specifies a network access identifier (NAI) associated with the selected network.

33. An apparatus according to claim 32, wherein the message is forwarded to the network service provider, and the network access identifier within the message is modified by the network service provider, the modified message being forwarded to the selected network.

34. An apparatus according to claim 33, wherein the message is compliant with an extensible authentication protocol (EAP).

35. An apparatus according to claim 31, wherein the user equipment supports Institute of Electrical and Electronic Engineers (IEEE) 802.16 WiMax protocols, and the selected network is a Third Generation Partnership Project (3GPP) system.

36. An apparatus according to claim 31, wherein the user equipment is configured to present the list to the user for manual selection, or to compare the list with a list of available network service providers.
